(19) United States
(12) Patent Application Publication
(10) Pub. No.: US 2008/0080177 A1
(43) Pub. Date: Apr. 3, 2008

(54) LIGHT EMITTING DIODE MODULE AND BACKLIGHT SYSTEM USING THE SAME

(75) Inventor: SHAO-HAN CHANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/623,294

(22) Filed: Jan. 15, 2007

(30) Foreign Application Priority Data
Sep. 29, 2006 (CN) 200610200949.1

(51) Int. Cl. F21V 9/00

(52) U.S. Cl. 362/231

(57) ABSTRACT

An exemplary light emitting diode module (10) includes plural light emitting units (12) arranged on a circuit board (11). Each light emitting unit includes two first light emitting diodes (121a, 121b), a second light emitting diode (122) and a third light emitting diode (123). The first, second, and third light emitting diodes are electrically connected with the circuit board. The first, second, and third light emitting diodes are arranged in the shape of a polygon, with each of the first, second, and third light emitting diodes being at a respective corner of the polygon.

### BACKGROUND OF THE INVENTION

1. Field of the Invention

The present invention relates to light sources, and particularly to a light emitting diode (LED) module and a backlight system using the LED module.

2. Discussion of the Related Art

LEDs are semiconductors that convert electrical energy into light energy. Compared to conventional light sources, LEDs generate relatively little heat, and have high energy conversion efficiency, high radiance (that is, they emit a large quantity of light per unit area), long service lifetime, high response speed, and good reliability.

White light is a mixture of different wavelengths across the visible light spectrum. Common LEDs cannot produce white light. Instead, any particular common LED produces light in one narrow wavelength band. Generally, a combination of light in three primary colors, i.e. a mixture of red, green, and blue light, produces white light. In fact, any desired color of light may be produced with an appropriate combination of these three primary colors of light. By combining red, green, and blue LEDs in a tightly coupled pattern, an impure form of white light is produced. Theoretically, by adjusting the relative intensity of the light emitted by the red, green, and blue LEDs, any color light source can be obtained.

Referring to FIG. 8, a backlight system 100a is shown. The backlight system 100a includes three LED modules 10a. Each of the LED modules 10a includes a circuit board 11a, and a plurality of LED units 13a arranged in a line on the circuit board 11a. Each of the LED units 13a includes two green LEDs 131a, 131b, a red LED 132a, and a blue LED 133a. The green LED 131a, the red LED 132a, the blue LED 133a, and the green LED 131b are arranged in a line from left to right on the circuit board 11a.

In the backlight system 100a, heat generated by each of the LED units 13a is small. However, in order to obtain a higher intensity of emitting light for the backlight system 100a, the LED module 10a includes the plurality of LED units 13a. Because the LEDs 131a, 132a, 133a, 131 b of each of the LED units 13a are arranged in the line, the heat emitted by the LED units 13a is amassed and concentrated in a local portion of the backlight system 100a. Furthermore, it can be difficult to properly dissipate the heat, whereby overheating in the local portion of the backlight system 100a occurs.

Therefore, a new LED module is desired in order to overcome the above-described shortcomings.

### SUMMARY

A light emitting diode module includes at least one light emitting unit arranged on a circuit board. The at least one light emitting unit includes two first light emitting diodes, a second light emitting diode and a third light emitting diode. The first, second, and third light emitting diodes are electrically connected with the circuit board. The first, second, and third light emitting diodes are arranged in the shape of a polygon, with each of the first, second, and third light emitting diodes being at a respective corner of the polygon.

Other advantages and novel features will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present LED module. Moreover, in the drawings, like reference numerals designate corresponding parts throughout the several views, and all the views are schematic.

FIG. 1 is a top plan view of an LED module in accordance with a first embodiment of the present invention.

FIG. 2 is a top plan view of an LED module in accordance with a second embodiment of the present invention.

FIG. 3 is a top plan view of an LED module in accordance with a third embodiment of the present invention.

FIG. 4 is a top plan view of an LED module in accordance with a fourth embodiment of the present invention.

FIG. 5 is a top plan view of an LED module in accordance with a fifth embodiment of the present invention.

FIG. 6 is a top plan view of a backlight system in accordance with a sixth embodiment of the present invention.

FIG. 7 is a top plan view of a backlight system in accordance with a seventh embodiment of the present invention.

FIG. 8 is a top plan view of a conventional backlight system.

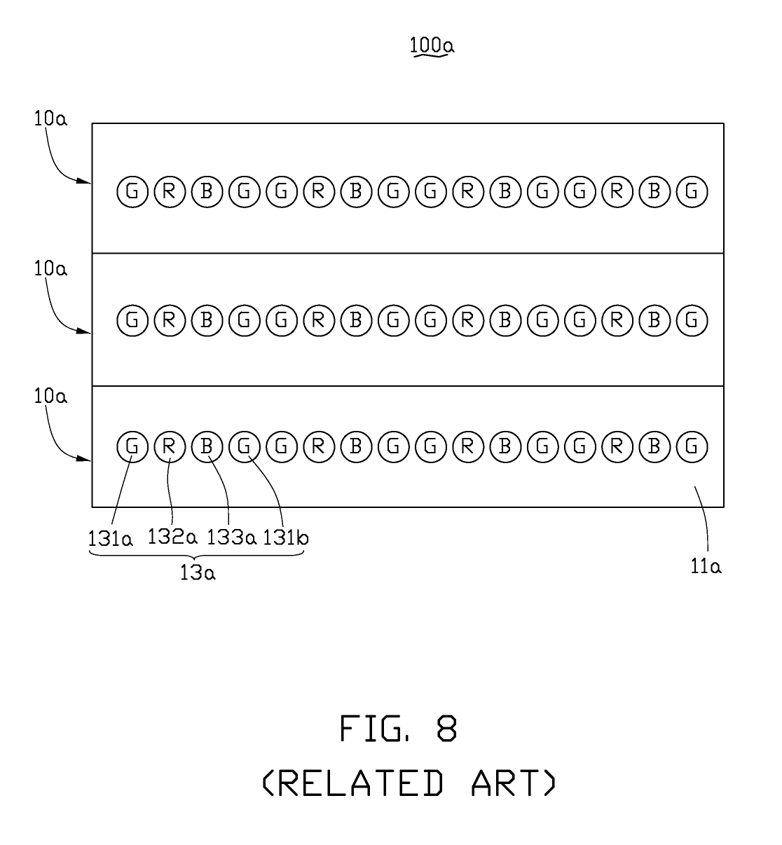

### DETAILED DESCRIPTION OF THE EMBODIMENTS

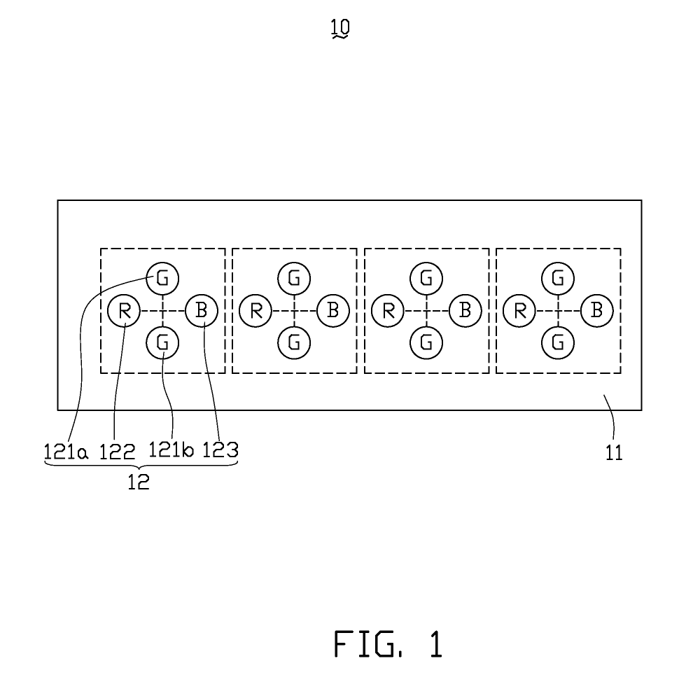

Referring to the drawings in detail, FIG. 1 shows a light emitting diode (LED) module 10 according to a first preferred embodiment. The LED module 10 includes at least one light emitting unit 12 arranged on a circuit board 11. In the illustrated embodiment, the LED module 10 includes four light emitting units 12.

The circuit board 11 is mainly comprised of metallic material, for example aluminum. The circuit board 11 is substantially an elongated rectangular plate. Each of the light emitting units 12 includes two first LEDs 121a, 121b, a second LED 122, and a third LED 123. A color of emitting light of each of the first, second, and third LEDs 121a, 121b, 122, 123 corresponds to a desired color of emitting light of the LED module 10. In the illustrated embodiment, it is desired that the LED module 10 emit white light. Thus, each of the first LEDs 121a, 121b is substantially a green light emitting diode, each of the second LEDs 122 is substantially a red light emitting diode, and each of the third LEDs 123 is substantially a blue light emitting diode.

The light emitting units 12 are arranged on the circuit board 11 linearly. In each of the light emitting units 12, the first, second, and third LEDs 121a, 121b, 122, and 123 are electrically connected with the circuit board 11. The first, second, and third LEDs 121a, 121b, 122, and 123 are arranged in a cross. Put another way, the first, second, and third LEDs 121a, 121b, 122, 123 are configured in the shape of a polygon, with each of the first, second, and third LEDs 121a, 121b, 122, 123 being at a respective corner of the polygon. In the illustrated embodiment, the polygon is substantially a parallelogram, and diagonals of the polygon intersect at right angles. In alternative embodiments, the polygon may for example be a quadrangle or a triangle. When the LED module 10 is considered as a whole, the first LEDs 121a are arranged in a first row, the first LEDs 121b are arranged in a third row, and the second and third LEDs 122, 123 are alternately arranged in a second row. The first, second, and third rows are parallel to each other, with the second row being between the first and third rows.

When the LED module 10 is in use, the light emitting units 12 generate light. In each of the light emitting units 12, the four light emitting diodes 121a, 121b, 122, and 123 are spaced apart from one another, while still being sufficiently close to each other to provide effective mixing of light colors and relatively uniform output of mixed light. Further, a distance between each two adjacent light emitting units 12 is relatively large, while still being sufficiently small to provide effective mixing of light colors and relatively uniform output of mixed light. In summary, the four light emitting diodes 121a, 121b, 122, 123 are spaced apart from and evenly distributed relative to each other, in a decentralized arrangement. Therefore overheating of a local portion or portions of the LED module 10 is avoided, and a heat dissipation performance of the LED module 10 is improved.

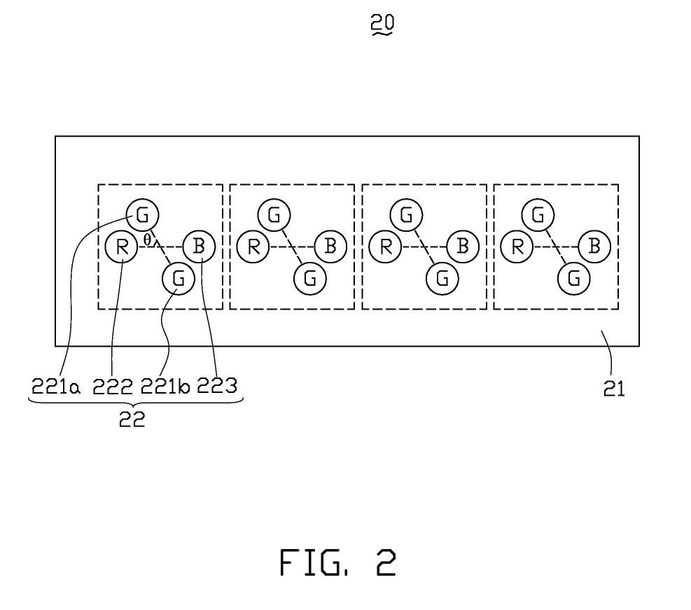

Referring to FIG. 2, an LED module 20 according to a second embodiment is shown. The LED module 20 is similar in principle to the LED module 10 described above. However, the LED module 20 includes four light emitting units 22 arranged on a circuit board 21. Each of the light emitting units 22 includes two first LEDs 221a, 221b, a second LED 222, and a third LED 223. In each of the light emitting units 22, the first, second, and third LEDs 221a, 221b, 222, and 223 are electrically connected with the circuit board 21. The first, second, and third LEDs 221a, 221b, 222, 223 are arranged in the shape of a polygon, with each of the first, second, and third LEDs 221a, 221b, 222, 223 being at a respective corner of the polygon. Diagonals of the polygon intersect at an acute angle, which is defined as θ. In the illustrated embodiment, θ is equal to 60 degrees.

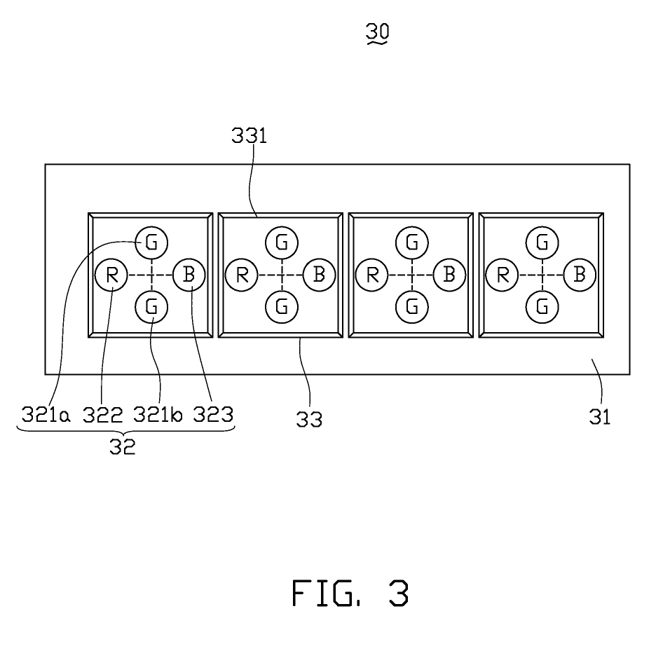

Referring to FIG. 3, an LED module 30 according to a third embodiment is shown. The LED module 30 is similar in principle to the LED module 10 described above. However, the LED module 30 includes four light emitting units 32 arranged on a circuit board 31. Each of the light emitting units 32 includes two first LEDs 321a, 321b, a second LED 322, and a third LED 323. The LED module 30 further includes four reflective enclosures 33 arranged on the circuit board 31. That is, the number of reflective enclosures 33 corresponds to the number of light emitting units 32. Each of the reflective enclosures 33 is disposed around a respective one of the light emitting units 32. Each of the reflective enclosures 33 is substantially a polygon. In the illustrated embodiment, each reflective enclosure 33 is rectangular, and includes four reflective dividers 331. Each of the reflective dividers 331 is made of a high light reflectivity material. Some of the light produced by the light emitting unit 32 is reflected by the corresponding reflective enclosure 33. Therefore further effective mixing of light colors can be attained, so that the LED module 30 has improved uniformity of output mixed light.

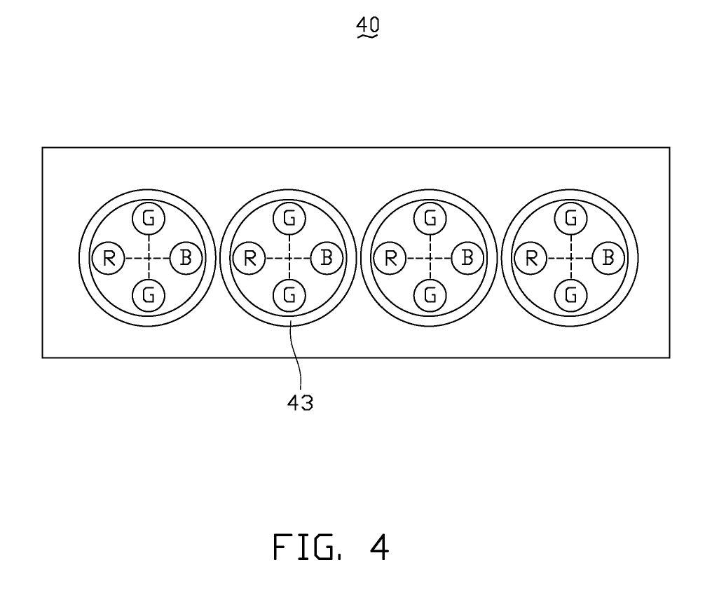

Referring to FIG. 4, an LED module 40 according to a fourth embodiment is shown. The LED module 40 is similar in principle to the LED module 30 described above. However, the LED module 40 includes four reflective enclosures 43. Each of the reflective enclosures 43 is substantially round.

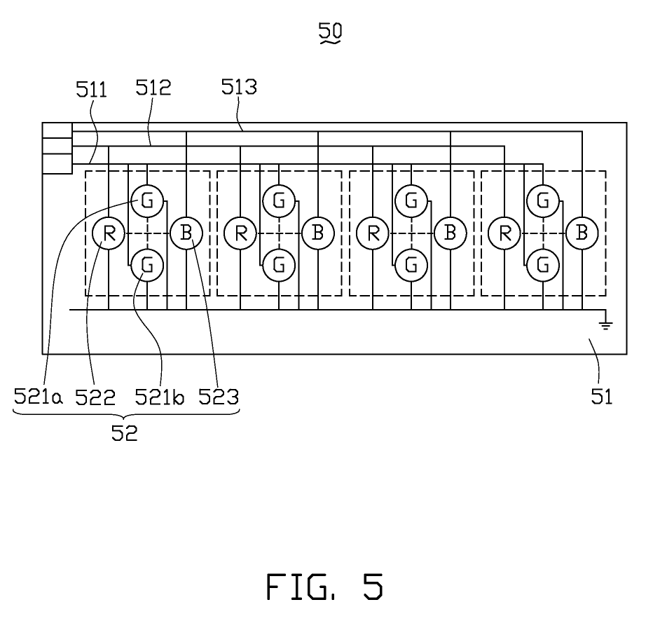

Referring to FIG. 5, an LED module 50 according to a fifth embodiment is shown. The LED module 50 is similar in principle to the LED module 10 described above. However, the LED module 50 includes four light emitting units 52 arranged on a circuit board 51. Each of the light emitting units 52 includes two first LEDs 521a, 521b, a second LED 522, and a third LED 523. The LED module 50 further includes a first wire 511, a second wire 512, and a third wire 513. The first LEDs 521a, 521b are connected in parallel by the first wire 511. The second LEDs 522 are connected in parallel by the second wire 512. The third LEDs 523 are connected in parallel by the third wire 513. Thus the LED module 50 can conveniently control the first LEDs 521a, 521b, the second LEDs 522, and the third LEDs 523 to emit respective amounts of light as desired, in order to change a color of the mixed light output from the LED module 50. In addition, the light emitting units 52 are connected in parallel by another wire (not shown). Thus the LED module 50 can control an intensity of mixed light output therefrom.

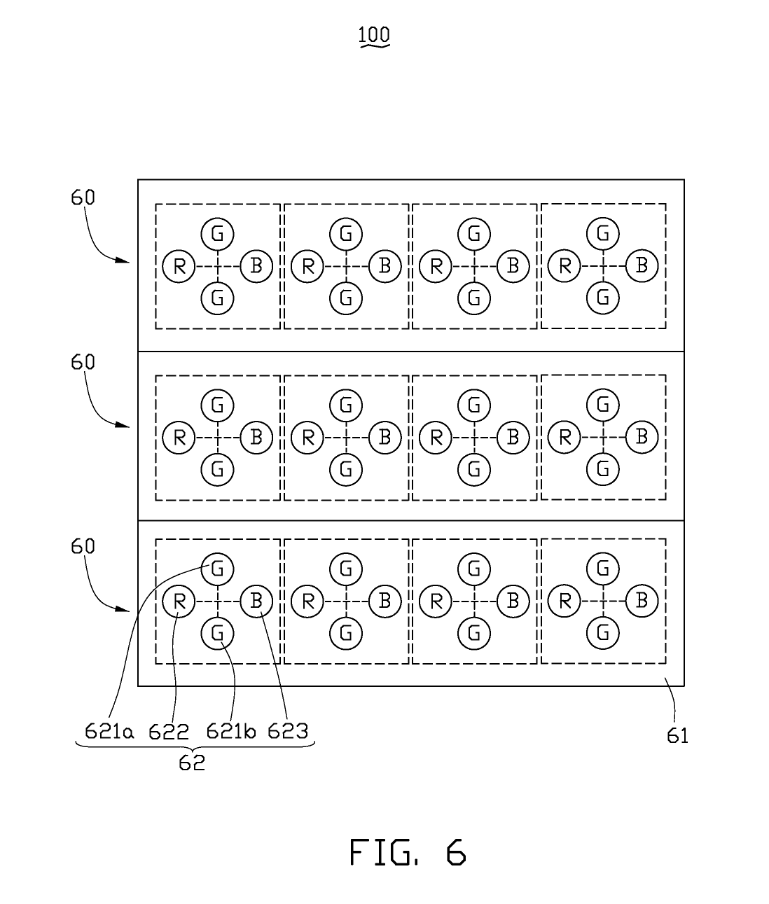

Referring to FIG. 6, a backlight system 100 according to a sixth embodiment is shown. The backlight system 100 includes at least one LED module 60. In the illustrated embodiment, the backlight system 100 includes three LED modules 60 arranged closely together side by side. Each of the LED modules 60 is substantially the same as the LED module 10, and includes four light emitting units 62 arranged on a circuit board 61. Each of the light emitting units 62 includes two first LEDs 621a, 621b, a second LED 622, and a third LED 623.

In one aspect, the light emitting units 62 of the backlight system 100 can be considered to be arranged in a matrix. Thus in each column of light emitting units 62, the LEDs 621a, 621b, 622, and 623 are arranged in three columns. A first one of the LED columns comprises the second LEDs 622, a second one of the LED columns comprises the first LEDs 621a, 621b. A third one of the LED columns comprises the third LEDs 623. The first, second and third LED columns are arranged in that order from left to right. The backlight system 100 has a total of twelve LED columns. In each column of light emitting units 62, the number of first LEDs 621a, 621b is double the number of second LEDs 622, and double the number of third LEDs 623. In another respect, in each LED module 60, the LEDs 621a, 621 b, 622, and 623 are arranged in three rows. A first one of the rows comprises the first LEDs 621a, a second one of the rows comprises the second LEDs 622 and the third LEDs 623, and a third one of the rows comprises the first LEDs 621b. The first, second and third rows are arranged in that order from top to bottom. The backlight system 100 has a total of nine rows. In each LED module 60, the combined number of second and third LEDs 622, 623 in the second row is double the number of first LEDs 621a in the first row, and double the number of first LEDs 621b in the third row.

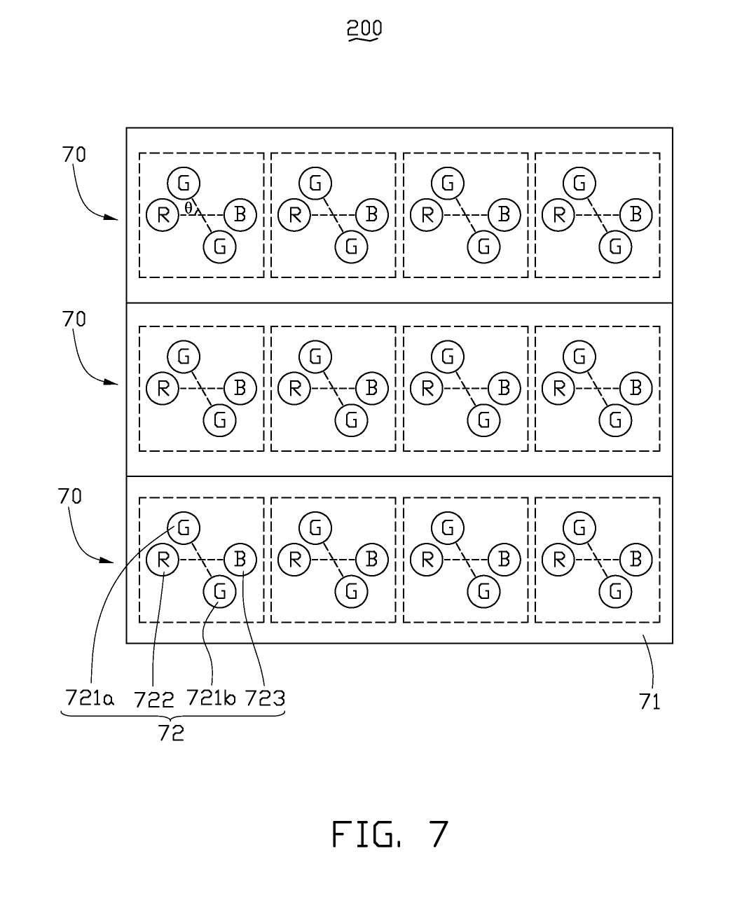

Referring to FIG. 7, a backlight system 200 according to a seventh embodiment is shown. The backlight system 200 is similar in principle to the backlight system 100 described above. However, the backlight system 200 includes three LED modules 70. Each of the LED modules 70 is substantially the same as the LED module 20, and includes four light emitting units 72 arranged on a circuit board 71. Each of the light emitting units 72 includes two first LEDs 721a, 721b, a second LED 722, and a third LED 723. In each of the light emitting units 72, the first, second, and third LEDs 721a, 721b, 722, and 723 are electrically connected with the circuit board 71. The first, second, and third LEDs 721a, 721b, 722, and 723 are arranged in the shape of a polygon, with each of the first, second, and third LEDs 721a, 721b, 722, and 723 being at a respective corner of the polygon. Diagonals of the polygon intersect at an acute angle, which is defined as θ. In the illustrated embodiment, θ is equal to 60 degrees.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. A light emitting diode module, comprising:
at least one light emitting unit arranged on a circuit board, the at least one light emitting unit including two first light emitting diodes, a second light emitting diode, and a third light emitting diode, wherein the first, second, and third light emitting diodes are electrically connected with the circuit board, and the first, second, and third light emitting diodes are arranged in the shape of a parallelogram, with each of the first second, and third light emitting diodes being at a respective corner of the parallelogram, the two first light emitting diodes arranged at two diagonally opposite corners of the parallelogram, and diagonals of the parallelogram intersecting at an acute angle.

2. (canceled)

3. The light emitting diode module as claimed in claim 1, wherein the circuit board is an elongated rectangular plate, the at least one light emitting unit is a plurality of light emitting units, and the light emitting units are arranged on the circuit board in a line.

4. The light emitting diode module as claimed in claim 1, wherein each of the two first light emitting diodes is a green light emitting diode, the second light emitting diode is a red light emitting diode, and the third light emitting diode is a blue light emitting diode.

5-6. (canceled)

7. The light emitting diode module as claimed in claim 1, further comprising at least one reflective enclosure arranged on the circuit board, the at least one reflective enclosure being disposed around the at least one light emitting unit.

8. The light emitting diode module as claimed in claim 7, wherein the at least one reflective enclosure has a shape that is one of rectangular and round.

9. The light emitting diode module as claimed in claim 1, wherein the at least one light emitting unit is four light emitting units, the first light emitting diodes of the light emitting units are connected in parallel, the second light emitting diodes of the light emitting units are connected in parallel, and the third light emitting diodes of the light emitting units are connected in parallel.

10. A backlight system, comprising at least two light emitting diode modules arranged side by side, each of the light emitting diode modules comprising:
at least one light emitting unit arranged on a circuit board, the at least one light emitting unit including two first light emitting diodes, a second light emitting diode, and a third light emitting diode, wherein the first, second, and third light emitting diodes are electrically connected with the circuit board, and the first, second, and third light emitting diodes are arranged in the shape of a parallelogram, with each of the first, second, and third light emitting diodes being at a respective corner of the parallelogram, the two first light emitting diodes arranged at two diagonally opposite corners of the parallelogram, and diagonals of the parallelogram intersecting at an acute angle.

11. The backlight system as claimed in claim 10, wherein each of the two first light emitting diodes is a green light emitting diode, the second light emitting diode is a red light emitting diode, and the third light emitting diode is a blue light emitting diode.

12. (canceled)

13. The backlight system as claimed in claim 10, wherein the at least one light emitting unit is at least two light emitting units adjacent each other, the backlight system defines a regular matrix of the light emitting units, in each of the light emitting diode modules, the first, second, and third light emitting diodes are arranged in three rows, a first one of the rows comprises a first plurality of the first light emitting diodes, a second one of the rows comprises the second light emitting diodes and the third light emitting diodes, and a third one of the rows comprises a second plurality of the first light emitting diodes.

14-16. (canceled)

17. The backlight system as claimed in claim 10, wherein the circuit board is an elongated rectangular plate, the at least one light emitting unit is a plurality of light emitting units, and the light emitting units are arranged on the circuit board in a line.

18. (canceled)
